(19) United States
(12) Patent Application Publication
(10) Pub. No.: US 2004/0240104 A1
(43) Pub. Date: Dec. 2, 2004

(54) Spindle motor with a welded disc clamp centering tube

(75) Inventors: Ljubomir Francuski, Spaichingen (DE); Milena Francuski, Spaichingen (DE)

Correspondence Address: SCHULTE ROTH & ZABEL LLP, ATTN: JOEL E. LUTZKER, 919 THIRD AVENUE, NEW YORK, NY, 10022, US

(73) Assignee: Minebea Co., Ltd., Nagano-Ken (JP)

(21) Appl. No.: 10/787,009

(22) Filed: Feb. 25, 2004

Related U.S. Application Data
(60) Provisional application No. 60/472,039, filed on May 20, 2003.

(51) Int. Cl. G11B 17/02

(52) U.S. Cl. 360/99.08

(57) ABSTRACT

A spindle motor having a rotating unit including a hub and a permanent magnet secured to the hub; a stationary unit including a bracket and a stator core with a coil winding; and a bearing unit including a fixed shaft mounted on the bracket, a bushing secured to the hub, a disc clamp centering tube and at least one bearing element supporting the bushing for its rotation with respect to the shaft. The disc clamp centering tube is welded to the hub of the rotating unit.

### CROSS-REFERENCE TO RELATED APPLICATIONS

This application claims all rights of priority to U.S. Provisional Patent Application Serial No. 60/472,039, filed May 20, 2003 (pending).

### FIELD OF INVENTION

The following application relates to the field of spindle motors and more specifically to a design that allows for more efficient manufacture of such motors.

### BACKGROUND OF THE INVENTION

Disc drive systems have been used in computers and other electronic devices for many years for storage of digital information. Information is recorded on concentric memory tracks of a magnetic disc medium, the actual information being stored in the form of magnetic transitions within the medium. The discs themselves are rotatably mounted on a shaft or “spindle”, the information being accessed by means of transducers located on a pivoting arm, which moves radially over the surface of the disc. The read/write heads or transducers must be accurately aligned with the storage tracks on the disc to ensure proper reading and writing of information; thus the discs must be rotationally stable.

Electric spindle motors are used to rotate the discs in disc drive systems. Such spindle motors may have either a fixed shaft and a rotating sleeve or a fixed sleeve and a rotating shaft. Depending on the type of spindle motor, a rotor hub is affixed to either the rotating shaft or to the rotating sleeve. The disc is then mounted on the rotor hub.

The spindle motor's shaft and sleeve must be rotatably mounted with respect to each other so as to allow relative rotation between the shaft and sleeve, but so as to minimize translational motion and tilting motion. Fluid dynamic bearings are the preferred method of providing such mounting, although conventional ball bearings are sometimes used.

In fluid dynamic bearings, lubricating fluid—either gas or liquid—functions as the bearing surface between the sleeve and the shaft. Pressure generating grooves on either the sleeve or the shaft generate pressure gradients in the fluid that prevent the sleeve and the shaft from contacting each other during motor operation. The bearing properties such as stiffness and energy consumption as well as the cost of the bearing are dependant upon many factors such as the bearing dimensions and shape, the positioning of the grooves, and the size of the gaps between the sleeve and shaft.

The requirements for a specific spindle motor vary depending on the application in which the spindle motor will be used. Since hard disc drives are used for a large variety of applications, there is a need for a variety of types of spindle motors to meet the specific requirements of the various applications. Accordingly, there is a need to efficiently manufacture a variety of types of spindle motors, where each type of spindle motor is closely matched to the specific requirements of the applications for which it will be used.

Two types of spindle motors are currently utilized in the industry, i.e., the spindle motor having a boss for centering a clamp integrated with the hub and a spindle motor with the boss being a separate part bonded to the hub. The manufacture of fluid dynamic bearings is a labor intensive process that requires numerous steps including machining the components, etching the grooves, applying oil repellent film, assembling the components, and adding the lubricant. In the prior art, as shown in FIG. 3, the separate bushing is bonded to the hub using an adhesive. Such manufacturing solution leads to a very high risk of uncured adhesive and high outgassing. It also adds an additional step of cutting into the manufacturing process

### SUMMARY OF THE INVENTION

It is therefore an object of the present invention to provide a spindle motor and a method of manufacturing a spindle motor that improves manufacturing efficiency and that allows for easily matching design specifications with manufacturing requirements.

One aspect of the present invention is a bearing unit for use in a spindle motor where the bushing is a discrete and separate component which is welded to the hub.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a cross sectional drawing showing a fluid dynamic bearing spindle motor embodying an aspect of the present invention.

FIG. 2 is a cross sectional drawing showing a ball bearing spindle motor embodying an aspect of the present invention.

FIG. 3 is a cross sectional drawing showing a prior art spindle motor.

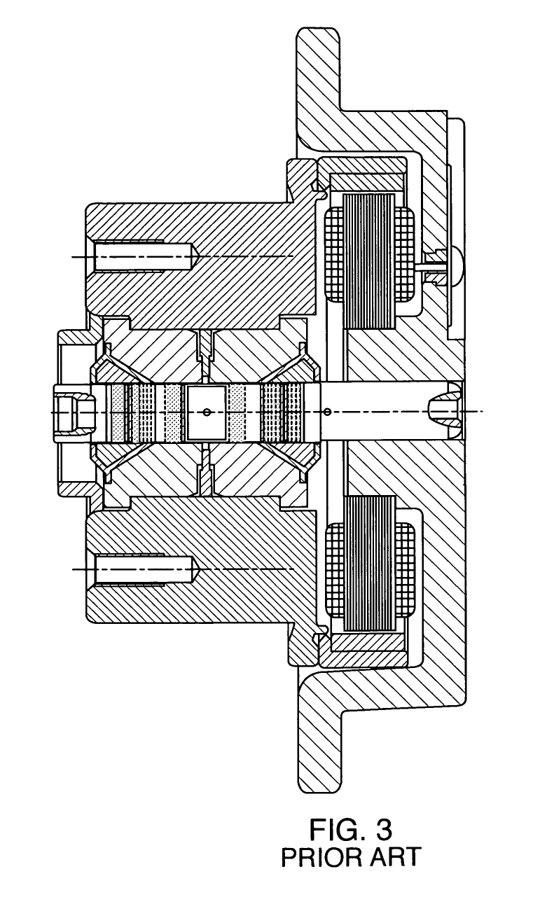

### DETAILED DESCRIPTION

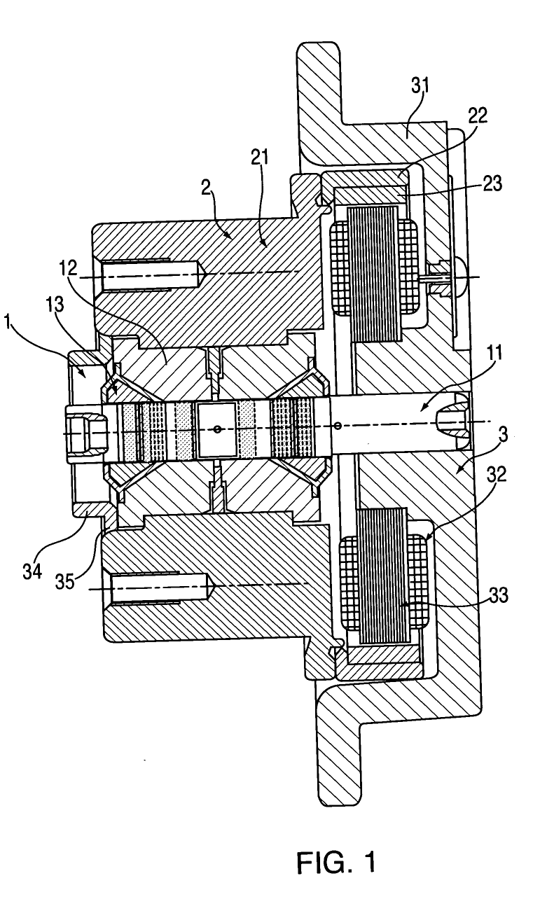

A spindle motor embodying the present invention is shown in FIG. 1. The spindle motor includes a bearing unit 1, rotating unit 2, and stationary unit 3. Bearing unit 1 supports the rotating unit 2 in its rotation with respect to stationary unit 3.

As shown in FIG. 1, rotating unit 2 has a rotor hub 21. A magnetic disc (not shown) or any other recording medium can be mounted for rotation on the rotor hub 21. The rotating unit 2 further includes yoke 22 and magnets 23. Magnets 23 are secured to the rotor hub 21 by the yoke 22.

Stationary unit 3 includes bracket 31, core 33, and coils 32. Bracket 31 attaches the spindle motor to a hard disc drive (not shown). Core 33 with coils 32 wound thereon are mounted onto bracket 31 such that they are placed in an opposing relationship with magnets 23 of the rotating unit 2. During operation, core 33 with coils 32 interact with magnets 23 to generate an electric field.

As shown in FIG. 1, bearing unit 1 includes a fixed shaft 11, rotating bushing 12, conical hydrodynamic bearing elements 13 and disc clamp centering tube 34. Conical bearing elements 13 have hydrodynamic pressure-generating grooves (not shown) formed thereon such that allow when rotating bushing 12 rotates about fixed shaft 11 hydrodynamic pressure gradients are developed preventing the bushing 12 from contacting fixed shaft 11. Bushing 12 is pressed into hub 21. Disc clamp centering tube 34 is assembled and fixed to the hub by welding. In the preferred embodiment, the same material is used for the hub 21 and the disc clamp centering tube 34. The welding can be accomplished as a circular welding seam 35 or just as a few welding spots.

Fixed shaft 11 of bearing unit 1 is affixed to bracket 31 of stationary unit 3. During operation of the spindle motor, core 33 and wound coil 32 generate a rotating electric field that applies a rotational force to magnets 23 coupled to rotating bushing 12 through yoke 22, rotor hub 21, and bushing 15. Accordingly, rotating bushing 12 and rotating unit 2 rotate about fixed shaft 11.

A spindle motor according to the present invention can be manufactured with a rotating shaft and a stationary bushing instead of a fixed shaft and a rotating bushing. In which case, the rotating shaft would be affixed to the rotating unit and the stationary bushing would be affixed to the stationary unit.

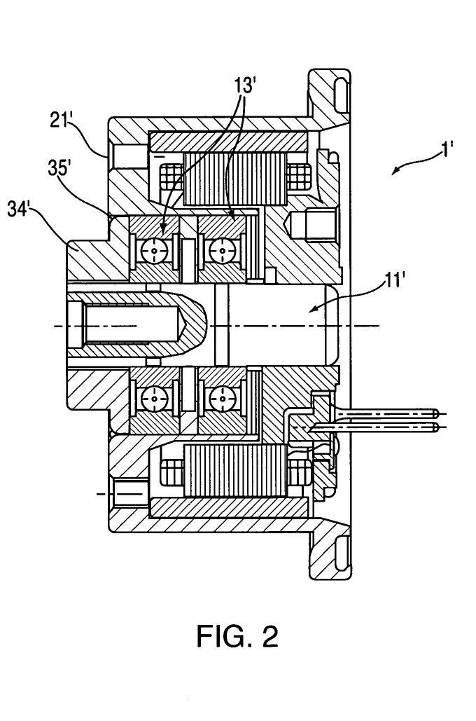

Additionally, even though the invention is described with respect to a hydrodynamic conical bearing assembly, it is not limited to such bearing assemblies. Other types of bearings can be used such as hydrodynamic thrust bearings, hydrodynamic journal bearings, pivot bearings, or ball bearings. For example, as shown in FIG. 2, the present invention can be utilized with a ball bearing assembly. In this embodiment, two ball bearings 13′ support the rotor hub 21′ in its rotation with respect to the fixed shaft 11′. The disc clamp centering tube 34′ is welded to the hub 21′ of the spindle motor. Similarly to the above hydrodynamic bearing embodiment, the hub and the disc clamp centering tube are preferably made of the same material.

In accordance with the invention, manufacturing of the spindle motor having a separate disc clamp centering tube welded to the hub of the spindle motor reduces the overall cost of manufacturing a spindle motor as it can be welded to the hub after the bearing system assembly in the hub has been finalized. Additionally, the risk of uncured adhesive and outgassing problem are completely eliminated.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

What is claimed is:

1. A spindle motor comprising:
a rotating unit including a hub and a permanent magnet secured to said hub;
a stationary unit including a bracket and a stator core with a coil winding; and
a bearing unit including a fixed shaft mounted on said bracket, a bushing secured to said hub, a disc clamp centering tube and at least one bearing element supporting said bushing for its rotation with respect to said shaft,
wherein said disc clamp centering tube is welded to the hub of the rotating unit.

2. The spindle motor according to claim 1, wherein said at least one bearing element is a hydrodynamic bearing.

3. The spindle motor according to claim 1, wherein said at least one bearing element is a conical hydrodynamic bearing.

4. The spindle motor according to claim 1, wherein said at least one bearing is a ball bearing.

5. The spindle motor according to claim 1, wherein said disc clamp centering tube and said hub are made from the same material.

6. A bearing unit for use in a spindle motor comprising:
a shaft;
a hub;
a bushing; and
a disc clamp centering tube,
wherein said disc clamp centering tube is welded to said hub.

7. The bearing unit for use in a spindle motor according to claim 6 further comprising at least one bearing element.

8. The bearing unit for use in a spindle motor according to claim 7, wherein said at least one bearing element is a hydrodynamic bearing.

9. The bearing unit for use in a spindle motor according to claim 7, wherein said at least one bearing element is a conical hydrodynamic bearing.

10. The bearing unit for use in a spindle motor according to claim 7, wherein said at least one bearing is a ball bearing.

11. The bearing unit for use in a spindle motor according to claim 6, wherein said disc clamp centering tube and said hub are made from the same material.
